(19) United States
(12) Patent Application Publication
(10) Pub. No.: US 2018/0036801 A1
(43) Pub. Date: Feb. 8, 2018

(54) THREE-DIMENSIONAL MANUFACTURING METHOD

(71) Applicant: Kabushiki Kaisha Toshiba, Minato-ku (JP)

(72) Inventors: Haruhiko ISHIHARA, Yokohama (JP); Takayuki FUKASAWA, Yokohama (JP); Masahiro KATO, Naka (JP); Sara YOSHIO, Taito (JP); Takashi KUBOKI, Ota (JP)

(73) Assignee: Kabushiki Kaisha Toshiba, Minato-ku (JP)

(21) Appl. No.: 15/556,232

(22) PCT Filed: Sep. 14, 2015
(86) PCT No.: PCT/JP2015/076053

§ 371 Date: Sep. 6, 2017

(30) Foreign Application Priority Data
Mar. 18, 2015 (JP) 2015-055228

(51) Int. Cl. B22F 3/105; B33Y 40/00; B28B 11/24; B28B 1/00; B33Y 10/00

(52) U.S. Cl. CPC B22F 3/1055; B28B 1/001; B33Y 10/00; B28B 11/243; B33Y 40/00

(57) ABSTRACT

A three-dimensional manufacturing method includes: forming and adding a layer of secondary particles to manufacture a three-dimensional object, the secondary particles obtained by granulating primary particles; and heating the three-dimensional object to produce a sintered compact.

### FIELD

Embodiments of the present invention relate to a three-dimensional manufacturing method.

### BACKGROUND

Conventionally, there have been developed various three-dimensional manufacturing methods for manufacturing three-dimensional objects, including a process of forming a powder layer on a manufacturing stage; and a binding process of discharging a binding agent from an inkjet head to a predetermined area of the accumulated powder layer to form a cured layer, for example. By repeating the processes, three-dimensional objects are manufactured.

### CITATION LIST

### Patent Literature

Patent Literature 1: Japanese Patent Application Laid-open No. 2010-208069

### SUMMARY OF THE INVENTION

### Problem to be Solved by the Invention

It is difficult to form a uniform powder layer from powder of reduced particle size due to aggregation by particle interaction, which also makes it difficult to manufacture three-dimensional objects in constant quality. To form a desirable powder layer, powder of a particle size of about several tens of micrometers is needed. Thus, large gaps among the particles cause a problem in reduced density and strength of three-dimensional manufactured objects. In the case of using a mixture of two or more materials having different particle sizes and properties, it is difficult to uniformly disperse the materials in the powder layer and provide three-dimensional objects with constant quality.

In view of the above, the present invention aims to provide a three-dimensional manufacturing method that can increase the density and the strength of a three-dimensional manufactured object and can manufacture three-dimensional objects with constant quality from a mixture of two or more materials.

### Means for Solving Problem

A three-dimensional manufacturing method according the embodiment comprises: an additive manufacturing process for forming and adding a layer of secondary particles to manufacture a three-dimensional object, the secondary particles obtained by granulating primary particles; and a sintering process for heating the three-dimensional object to produce a sintered compact

### BRIEF DESCRIPTION OF DRAWINGS

FIG. 1 is a schematic diagram for explaining the configuration and processes of a three-dimensional manufacturing system according to a first embodiment.

FIG. 2 is a schematic sectional view of the configuration of a three-dimensional printer.

FIG. 3 is a conceptual diagram for explaining a three-dimensional manufacturing method according to the first embodiment.

FIG. 4 is a diagram for explaining a state of secondary particles in pressurization.

FIG. 5 is a schematic diagram for explaining the configuration and processes of the three-dimensional manufacturing system according to a second embodiment.

FIG. 6 is a conceptual diagram for explaining the three-dimensional manufacturing method according to the second embodiment.

FIG. 7 is a perspective view of the appearance of an example of a three-dimensional object having a recess (hollow) manufactured by the three-dimensional manufacturing method according to the second embodiment.

FIG. 8 is a diagram for explaining examples of a combination of primary particles.

FIG. 9 is a schematic sectional view of a three-dimensional printer according to a modification of the embodiments.

FIG. 10 is a perspective view of a main part of a manufacturing tank and a supply device.

FIG. 11 is a schematic sectional view of a three-dimensional printer according to a second modification of the embodiments.

### DETAILED DESCRIPTION

Embodiments will be described with reference to the accompanying drawings.

### [1] First Embodiment

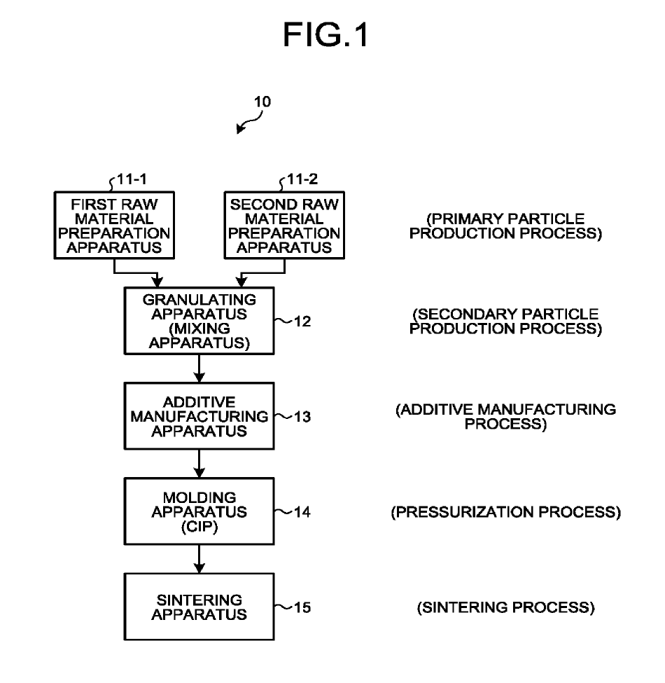

FIG. 1 is a schematic diagram for explaining the configuration and processes of a three-dimensional manufacturing system according to a first embodiment. A three-dimensional manufacturing system 10 according to the first embodiment includes a plurality of (two in FIG. 1) raw material preparation apparatuses 11 (a first raw material preparation apparatus 11-1 and a second raw material preparation apparatus 11-2) and a granulating apparatus 12. The raw material preparation apparatuses 11 prepare primary particles having different outer shapes. The granulating apparatus 12 mixes the primary particles prepared by the first raw material preparation apparatus 11-1 and the primary particles prepared by the second raw material preparation apparatus 11-2 with a binder (binding agent) and granulates them to produce secondary particles.

The three-dimensional manufacturing system 10 includes an additive manufacturing apparatus 13, a molding apparatus (TIP: cold isostatic pressing) 14, and a sintering apparatus 15. The additive manufacturing apparatus 13 is what is called a three-dimensional printer and forms and adds layers of the secondary particles to manufacture a three-dimensional object. The molding apparatus 14 puts the three-dimensional object manufactured by the additive manufacturing apparatus 13 into a rubber mold and applies isotropic pressure thereto. The sintering apparatus 15 heats and sinters the three-dimensional object after the isotropic pressure application in accordance with a predetermined temperature rising and falling pattern to provide a sintered compact.

The raw material preparation apparatuses 11 are described first. The first raw material preparation apparatus 11-1 and the second raw material preparation apparatus 11-2 are collectively described because they have the same configuration.

First, the materials of the primary particles are described. Examples of the materials of the primary particles include, but are not limited to: oxide materials (metal oxides), such as SiO₂, alumina (Al₂O₃), zirconia (ZrO₂), titanium oxide (TiO₂), barium titanate (BaTiC₃), lead zirconate titanate (Pb(Zr,Ti)O₃), zircon (ZrO₂.SiO₂), cordierite (2MgO.2Al₂O₃.5SiO₂), forsterite (2MgO.SiO₂), mullite (3Al₂O₃.2SiO₂), and steatite (MgO.SiO₂); nitride materials (metal nitrides), such as silicon nitride (SiN), aluminum nitride (AlN), titanium nitride (TiN), and boron nitride (NW; and carbide materials, such as silicon carbide (SiC).

The outer shape of the primary particles may be various shapes, such as a spherical shape, an ellipsoidal shape, an acicular shape, and a platy shape. In this case, the primary particles formed by the first raw material preparation apparatus 11-1 and the second raw material preparation apparatus 11-2 preferably have different outer shapes. Having the same outer shape, the primary particles preferably differ in particle distribution from each other. This is intended to fill the gaps between the secondary particles for densification by plastically deforming the secondary particles in the pressure molding by the molding apparatus 14.

The first raw, material preparation apparatus 11-1 and the second raw material preparation apparatus 11-2 are apparatuses that appropriately add an auxiliary agent, such as a binder, to a powdered ceramic raw material (main material) produced by a solid phase method, a liquid phase method, or a gas phase method and subjects the material to crushing, dispersion, mixing, and other processing. The first raw material preparation apparatus 11-1 and the second raw material preparation apparatus 11-2 are, for example, crushing and mixing apparatuses, such as ball mills, bead mills, and jet mills. Furthermore, the first raw material preparation apparatus 11-1 and the second raw material preparation apparatus 11-2 are spray driers as needed, for example.

Next, the granulating apparatus 12 is described. The granulating apparatus 12 receives a predetermined ratio of the primary particles prepared by the first raw material preparation apparatus 11-1 and the primary particles prepared by the second raw material preparation apparatus 11-2, and a predetermined binder as an auxiliary agent, and granulates them to produce the secondary particles. The granulating apparatus is a crushing and mixing apparatus, such as a bail mill, a bead mill, and a jet mill, for example.

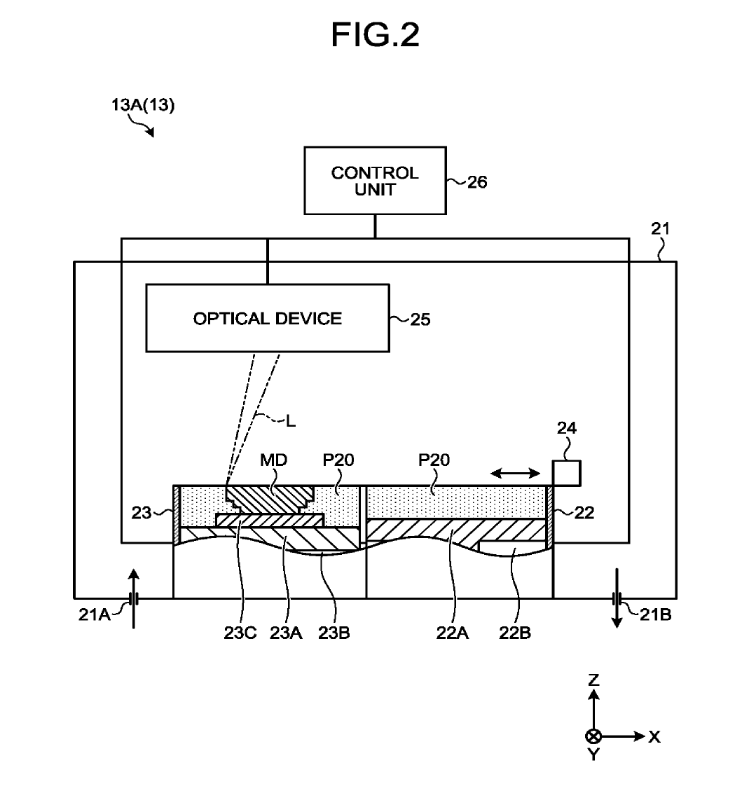

The following describes a three-dimensional printer 13A serving as the additive manufacturing apparatus 13. FIG. 2 is a schematic sectional view of the configuration of the three-dimensional printer. The three-dimensional printer 13A includes a treatment chamber 21, a material tank 22, a manufacturing tank 23, a wiper device 24, an optical device 25, and a control unit 26. The treatment chamber 21 maintains a clean space for three-dimensional manufacturing (specially for material oxidation prevention). The material tank 22 accommodates raw materials (secondary particles) of a three-dimensional object. The manufacturing tank 23 is for actual three-dimensional manufacturing. The wiper device 24 supplies the raw materials from the material tank 22 to the manufacturing tank 23. The optical device 25 emits laser light to each layer of the raw materials (secondary particles), supplied from the wiper device 24 to the manufacturing tank 23, at a position (pattern) corresponding to each layer of the three-dimensional object corresponding to slice data. The control unit 26 controls the material tank 22, the manufacturing tank 23, the wiper device 24, and the optical device 25.

In the above configuration, the treatment chamber 21 has a sealed space inside. The material tank 22, the manufacturing tank 23, the wiper device 24, and the optical device 25 are arranged at predetermined positions in the treatment chamber 21. The treatment chamber 21 is supplied with an inert gas, such as nitrogen and argon, front a gas supplier (not illustrated) through a supply port 21A to maintain cleanliness inside the treatment chamber 21 and exhaust excessive gas components occurring in the three-dimensional manufacturing to outside the treatment chamber 21 through a vent 21B.

The material tank 22 includes a stage 22A which can be ascended and descended by a hydraulic lifting device 228. Secondary particles P20 serving as the raw materials are placed on the stage 22A. In three-dimensional manufacturing, the stage ascends in each predetermined manufacturing step to move the raw materials of an amount corresponding to a predetermined layer thickness upward in the material tank 22.

The manufacturing tank 23 is supplied with the raw materials from the material tank 22 by the wiper device 24. The manufacturing tank 23 includes a stage 23A on which a three-dimensional object is placed. The stage 23A can be ascended and descended by a hydraulic lifting device 233. A base plate 230 is placed on the stage 23A and supports the raw materials and the three-dimensional object as needed. A three-dimensional object MD is additively manufactured by repeatedly forming and adding a layer upon a layer of predetermined thickness. Thus, in the three-dimensional manufacturing, the stage 23A is descended stepwise in units of the predetermined layer thickness by the hydraulic lifting device 23B.

The wiper device 24 includes a squeezing blade. The squeezing blade is horizontally driven in FIG. 2, to supply the amount of the raw materials 22, corresponding to the predetermined layer thickness moved upward in the material tank 22, to the manufacturing tank 23 and level them to a uniform thickness.

The optical device 25 is placed above the manufacturing tank 23. The optical device 25 includes an oscillating element, for example. The optical device 25 includes an optical system including a light source, a collimator (collimator lens: convertor lens), a scanner, and a condenser lens (f-θ lens). The light source emits laser light L. The collimator converts the laser light L into parallel light. The scanner includes a galvanometer mirror that deflects the parallel laser light. The condenser lens condenses the laser light (beam) deflected by the scanner on a flat imaging plane for scanning.

The control unit 26 is what is called a microcomputer and has a basic configuration including an MPU, a ROM, a RAM, and a communication interface. The control unit 26 controls, via communication lines, the hydraulic lifting devices 225 and 23B in the material tank 22 or the manufacturing tank 23, a driving mechanism (not illustrated) of the squeezing blade of the wiper device 24, and the optical system of the optical device 25, for example.

The molding apparatus 14 includes a high-pressure container and a pressurizing device (not illustrated). The pressurizing device, such as a pump, applies pressure to a liquid (hydraulic medium: pressure transmitting medium) filling the high-pressure container. The sintering apparatus 15 includes a heater for heating and includes an electric furnace.

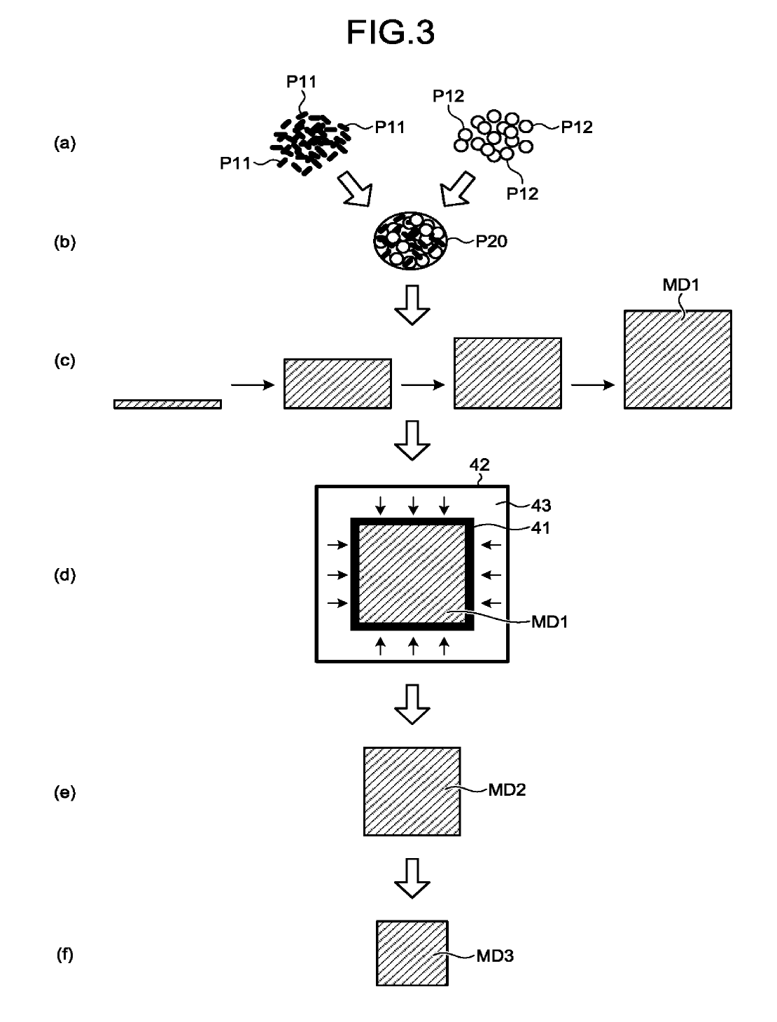

Referring back to FIG. 1, a three-dimensional additive manufacturing method according to the first embodiment is described. FIG. 3 is a conceptual diagram for explaining the three-dimensional additive manufacturing method according to the first embodiment. Upon receiving the respective powdered ceramic raw materials (main materials) and auxiliary agents, such as binders, the first raw material preparation apparatus 11-1 and the second raw material preparation apparatus 11-2 crush, disperse, and mix the materials to prepare a dispersed liquid of the primary particles (primary particle manufacture process: primary particle preparation process).

Specifically, as illustrated in FIG. 3(a), the first raw material preparation apparatus 11-1 produces primary particles P11 represented by black columnar particles in FIG. 3, whereas the second raw material preparation apparatus 11-2 produces primary particles P12 represented by white spherical particles in FIG. 3. The sizes of the primary particles P11 and the primary particles P12 are several micrometers or less.

The primary particles P11 and the primary particles P12 may be what is called nanoparticles having a nanometer size. Use of the nanoparticles can further increase reactivity, enabling manufacture of a three-dimensional object with higher density and strength.

The two primary particles P11 and P12 produced by the first raw material preparation apparatus 11-1 and the second raw material preparation apparatus 11-2 are injected into the granulating apparatus 12 at a predetermined ratio. The granulating apparatus 12 receives an injected predetermined binder (predetermined light curing resin, and a sintering aid as needed) as an auxiliary agent to the primary particles P11 and P12, to produce the secondary particles (secondary particle production process).

Specifically, as illustrated in FIG. 3(b), the granulating apparatus 12 produces the secondary particles P20 being granulated powder containing the two primary particles P11 and P12 at the predetermined ratio. The size of the secondary particles P20 is several tens of micrometers, sufficiently large to form a powder layer.

The secondary particles P20 granulated by the granulating apparatus 12 are injected into the material tank 22 of the three-dimensional printer 13A serving as the additive manufacturing apparatus 13. Subsequently, the treatment chamber 21 is supplied and filled with an inert gas, such as nitrogen and argon, from the gas supplier (not illustrated) to maintain the cleanliness inside the treatment chamber 21.

The secondary particles P20 are injected into the material tank 22 up to the uppermost part at a uniform height. In this state, the control unit 26 controls the wiper device 24. The squeezing blade of the wiper device 24 is horizontally driven in FIG. 2 under the control of the control unit 26. The squeezing blade thus supplies, to the manufacturing tank 23, the secondary particles (raw materials) P20 of the amount corresponding to a predetermined layer thickness moved upward in the material tank 22 while leveling them to a uniform thickness.

The secondary particles P20 levelled at the predetermined layer thickness in the manufacturing tank 23 are subjected to additive manufacturing by the optical device 25 under the control of the control unit 26 (additive manufacturing process). Specifically, the source of the optical device 25, placed above the manufacturing tank 23, generates laser light with the oscillating element and emits the laser light L to the collimator. The collimator converts the laser light L into parallel light and supplies it to the scanner (e.g., a pair of galvanometer mirrors).

The parallel laser light L is deflected by the scanner to draw a pattern based on slice data received from outside and reaches the condenser lens. The condenser lens condenses the laser light (beam) L deflected by the scanner on a flat imaging plane, that is, on newly supplied secondary particles P20 for scanning. As a result, the secondary particles P20 including the light curing resin are cured into a shape in accordance with the pattern based on the slice data.

Upon completion of the curing based on the slice data, the control unit 26 controls the hydraulic lifting device 2B to descend the stage by the predetermined layer thickness in the manufacturing tank 23. In parallel with this, the stage in the material tank is ascended by the hydraulic lifting device to be able to supply the secondary particles of the amount corresponding to the predetermined layer thickness to the manufacturing tank 23.

Subsequently, the control unit 26 controls the wiper device 24 to drive the squeezing blade of the wiper device 24 to supply the secondary particles to the top of the manufacturing tank 23 while leveling them to a uniform thickness. The optical device 25 emits the laser light L thereto again for the additive manufacturing of the next layer.

Until the entire slice data is processed, The supply of the secondary particles P20 from the material tank 22 and the curing of the light curing resin included as an auxiliary agent in the secondary particles P20 in the manufacturing tank 23 are repeated for three-dimensional additive manufacturing in the same manner as described above. Specifically, as illustrated in FIG. 3(c), the secondary particles P20 are gradually cured, layered, and added into a three-dimensional object MD1 having a square section as illustrated on the right side of FIG. 3(c).

Subsequently, the three-dimensional object MD1 manufactured by the three-dimensional printer 13A is put into a rubber container (rubber mold) 41 and placed in a high-pressure container 42. A pressurizer (not illustrated), applies pressure to a liquid 43 in the high-pressure container 42, thereby applying isotropic pressure (hydrostatic pressure) to the three-dimensional object MD1.

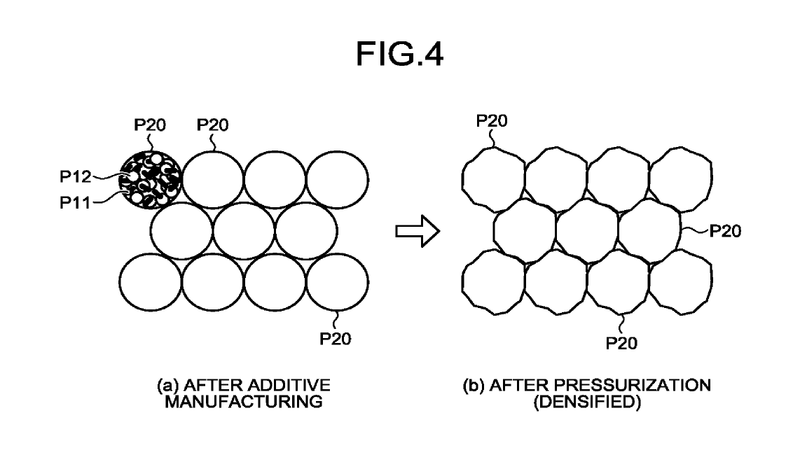

FIG. 4 is a diagram for explaining the state of the secondary particles in pressurization. As illustrated in FIG. 4(a), in the three-dimensional object manufactured by the three-dimensional manufacturing apparatus, the spherical-shape (or an ellipsoidal shape) secondary particles P20, for example are formed with gaps (holes) therebetween.

After the pressurization by the pressurizing device, the secondary particles P20 are however plastically deformed and densified with no gaps (holes), as illustrated in FIG. 4(b). As a result, in comparison with the three-dimensional object MD1 before isotropic pressure application, a three-dimensional object MD2 after the application is shrunk by about a volume corresponding to the gaps between the secondary particles P20, as illustrated in FIG. 3(e).

Subsequently, the three-dimensional object MD2 is extracted from the pressurizing device and the rubber container (rubber mold) 41, and subjected to heating by the sintering apparatus 15 in accordance with a predetermined temperature rising and falling pattern. The three-dimensional object MD2 is thus sintered into a three-dimensional object MD3 serving as a sintered compact. More specifically, as illustrated in FIG. 3(f), the three-dimensional object MD3 as a sintered compact is further shrunk in length to about 70%. The three-dimensional object MD3 is about 50% to 60% of the three-dimensional object MD2 after the isotropic pressure application by volume.

As described above, according to the first embodiment, the size of the secondary particles P20 is several tens of micrometers, which enables accurate formation of powder layers for three-dimensional additive manufacturing. Furthermore, the use of the primary particles P11 and P12 (e.g., crushed powder), of the secondary particles P20, having a size of several micrometers or less can result in reducing manufacturing costs and manufacturing densified three-dimensional objects (three-dimensional structures) having higher density and strength. In place of the isotropic pressure application under the cold condition above, the secondary particles P20 are applied with pressure by a pressurizing member, such as a press roller and a press plate, in parallel with the three-dimensional manufacturing.

### [2] Second Embodiment

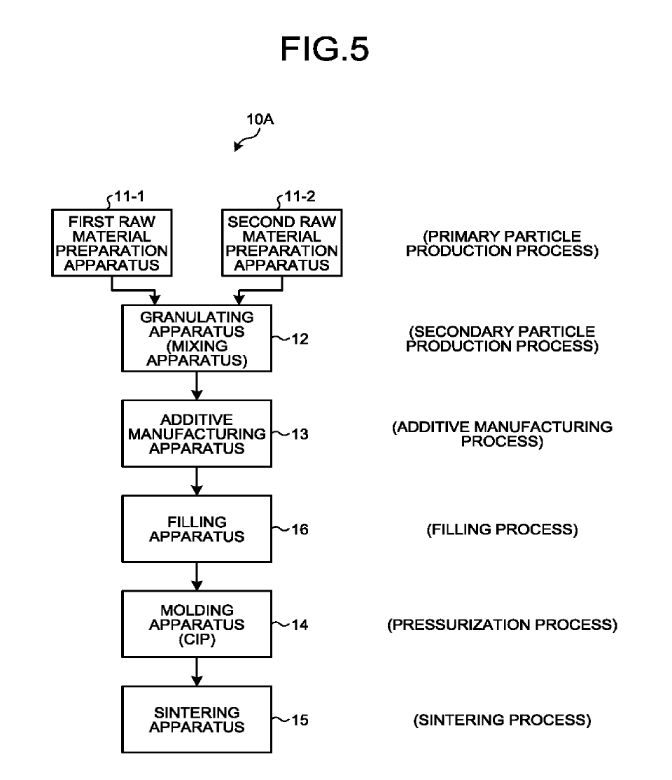

A second embodiment concerns manufacturing a three-dimensional object having a recess (specially, a hollow). FIG. 5 is a schematic diagram for explaining the configuration and processes of the three-dimensional manufacturing system according to the second embodiment. In FIG. 5, same or like components as those in FIG. 1 are denoted by the same reference numerals, and the detailed explanation thereof is incorporated.

A three-dimensional manufacturing system 10A according to the second embodiment is different from the three-dimensional manufacturing system 10 according to the first embodiment in additionally including a filling apparatus 16 which maintains the shape of the recess (hollow) in a three-dimensional object in the pressurization process and fills the recess (hollow) with a core material that sublimates in the sintering process. The filling process is conducted between the additive manufacturing process by the additive manufacturing apparatus 13 and the pressurization process by the molding apparatus 14. Examples of the core material include, but are not limited to, a sublimation material, such as naphthalene and anthracene.

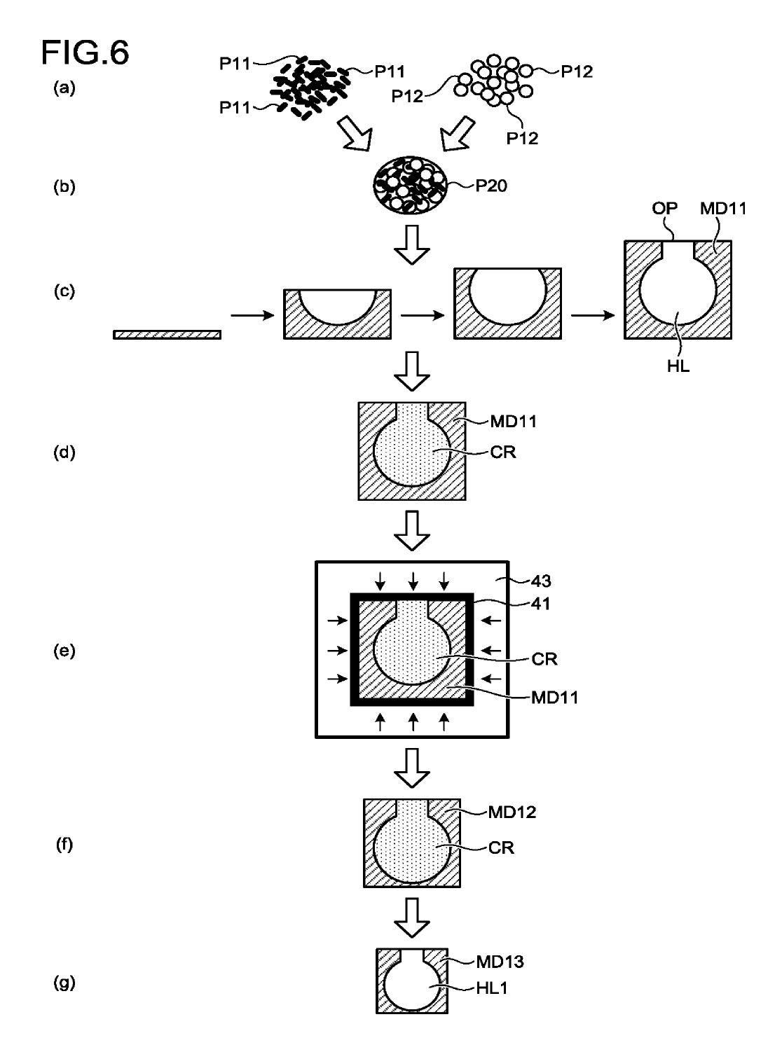

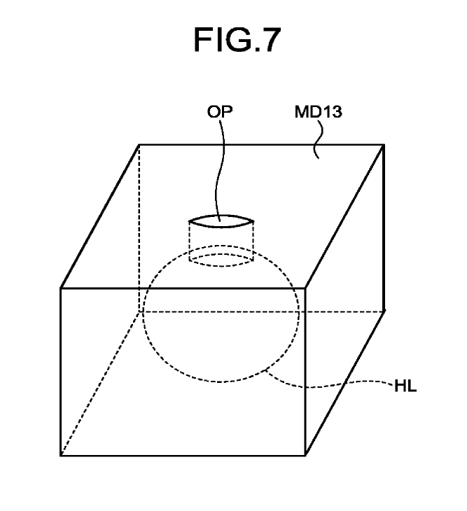

FIG. 6 is a conceptual diagram for explaining the three-dimensional manufacturing method according to the second embodiment. FIG. 7 is a perspective view of the appearance of an example of a three-dimensional object having a recess (hollow) created by the three-dimensional manufacturing method according to the second embodiment. As illustrated in FIG. 7, a three-dimensional object MD13 according to the second embodiment has a cuboid shape with a flask-like hollow HL with an opening OP in the top face.

In creating the three-dimensional object MD13 illustrated in FIG. 6, the primary particle production process using the first raw material preparation apparatus 11-1 and the second raw material preparation apparatus 11-2 and the secondary particle production process using the granulating apparatus 12 are the same as those according to the first embodiment. The detailed explanation thereof is therefore incorporated, and the description begins with the additive manufacturing process.

The secondary particles P20 are granulated by the granulating apparatus 12 and injected into the material tank 22 of the three-dimensional printer 13A serving as the additive manufacturing apparatus 13. Subsequently, the treatment chamber 21 is supplied and filled with the inert gas, such as nitrogen and argon, from the gas supplier (not illustrated) to maintain the cleanliness inside the treatment chamber 21.

The secondary particles P20 are injected into the material tank 22 up to the uppermost part of the material tank 22 at a uniform height. The squeezing blade of the wiper device 24 is driven under the control of the control unit 26 to supply, to the manufacturing tank 23, the secondary particles (raw materials) P20 of the amount corresponding to the predetermined layer thickness moved upward in the material tank 22 while leveling them to a uniform thickness.

The secondary particles P20 levelled to the predetermined layer thickness in the manufacturing tank 23 are subjected to the additive manufacturing by the optical device 25 under the control of the control unit (additive manufacturing process). Specifically, the secondary particles P20 including the light curing resin are formed into a shape in accordance with the pattern based on the slice data, that is, a three-dimensional object MD11 with a cuboid shape having the flask-like hollow HL with the opening OP in the top face, as illustrated in FIG. 6(c).

Upon completion of the curing based on the entire slice data, the control unit 26 controls the filling apparatus 16 so as to fill the hollow HL with a core material CR. Specifically, as illustrated in FIG. 6(d), the hollow HL in the three-dimensional object MD11 is filled with the core material CR up to the opening OP in the top face.

Subsequently, the three-dimensional object MD11 filled with the core material CR is put into the rubber container (rubber mold) 41 and placed in the high-pressure container 42 as illustrated in FIG. 6(e). The pressurizing device applies a pressure to the liquid 43 in the high-pressure container 42, thereby applying isotropic pressure (hydrostatic pressure) to the three-dimensional object MD11.

As a result, in comparison with the three-dimensional object MD11 before the isotropic pressure application, a three-dimensional object MD12 after the isotropic pressure application is contracted by approximately a volume corresponding to the gaps between the secondary particles P20 as illustrated in FIG. 6(f). However, the volume of the core material CR hardly changes, so that the shape of the hollow HL needs to be designed considering this property.

The three-dimensional object MD12 is then extracted from the pressurizing device and the rubber container (rubber mold) 41, and is subjected to heating by the sintering apparatus 15 in accordance with the predetermined temperature rising and falling pattern. The three-dimensional object MD12 is thus sintered into the three-dimensional object MD13 serving as a sintered compact. The three-dimensional object MD12 is rapidly heated until the temperature exceeds the sublimation point of the core material CR. As a result, the core material CR sublimates from a solid into a gas, leaving a hollow HL1 in the three-dimensional object MD13 as illustrated in FIG. 6(g).

More specifically, the three-dimensional object MD13 serving as a sintered compact is shrunk in length to about 70%, and becomes approximately 50% to 60% the size of the three-dimensional object MD12 after the isotropic pressure application by volume.

As described above, the second embodiment can provide a three-dimensional object having a recess. As with the first embodiment, the use of the secondary particles P20 of the size of several tens of micrometers enables accurate formation of powder layers for three-dimensional manufacturing.

Furthermore, the second embodiment can use the primary particles P11 and P12 (e.g., crushed powder), of the secondary particles P20, of several micrometers or less, which can lower manufacturing costs and provide densified three-dimensional manufactured objects (three-dimensional structures) having higher density and strength.

### [3] Third Embodiment

The above embodiments have not described thermal behavior of the primary particles P11 and P12 in detail. A third embodiment concerns reducing distortion in a three-dimensional object (three-dimensional structure) in view of the thermal behavior of the primary particles P11 and P12.

In this case, a three-dimensional object serving as a sintered compact can be created by the same procedure as that according to the first embodiment and the second embodiment. Alternatively, the molding apparatus (CIP: cold isostatic pressing) 14 that puts a three-dimensional object in a rubber mold and applies isotropic pressure thereto, and the isotopic pressure application process by the molding apparatus 14 may be omitted.

More specifically, to form a three-dimensional object before sintering in the third embodiment, the secondary particles P20 are made of primary particles P11 and P12, one of which is a metallic material and the other is an oxide of the metal. Thereby, the metallic part is oxidized during the heating and the three-dimensional object is sintered with the metal oxide by reaction sintering to at least partially offset a decrease in volume associated with sintering by an increase in volume associated with oxidation of the metallic material. Thereby, distortion in the three-dimensional object can be reduced.

Theoretically, the larger the volume expansion of metallic particles as the primary particles when oxidized, the smaller the volume ratio of the metallic particles to the secondary particles P20 is set. Thereby, the volume shrinkage associated with sintering is at least partially offset by the volume increase associated with oxidation of the metallic material.

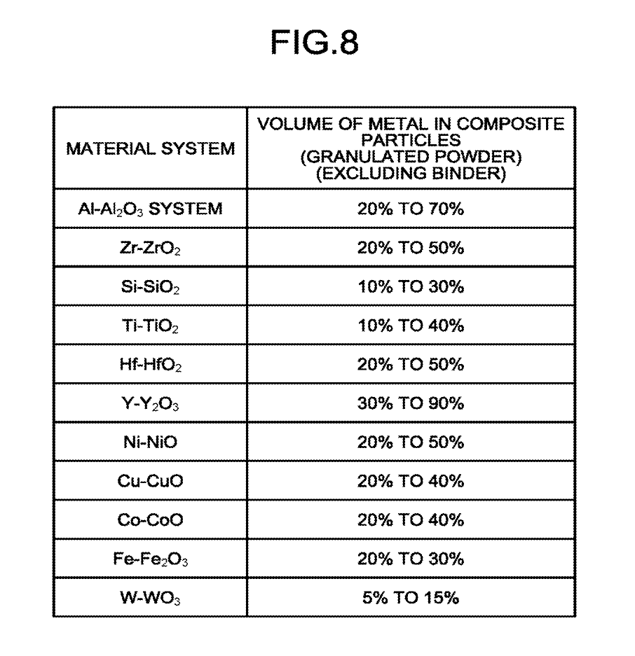

FIG. 8 is a diagram for explaining an example of combinations of the primary particles. When aluminum (Al) is used as the primary particles P11, for example, alumina (Al₂O₃) is used as the primary particles P12, and the volume, excluding the binder, of aluminum (metal) in the secondary particles P20 as composite particles is set to 20% to 70%, as illustrated in FIG. 8. Thereby, the volume shrinkage associated with sintering can be at least partially offset by the volume increase associated with oxidation of the metallic material, reducing distortion in the three-dimensional object.

If the volume, excluding the binder, of aluminum (metal) in the composite secondary particles P20 is smaller than 20%, the volume shrinkage associated with sintering becomes too large, whereby distortion of the object cannot be entirely eliminated. By contrast, if the volume, excluding the binder, of aluminum (metal) in the composite secondary particles P20 is larger than 70%, the volume increase in associated with oxidation of the metallic material becomes too large, whereby distortion of the object cannot be entirely eliminated.

Similarly, when zirconia (Zr) is used as the primary particles P11, zirconium dioxide (ZrO₂) may be used as the primary particles P12, and the volume, excluding the binder, of zirconium (metal) in the composite secondary particles P20 may be set to 20% to 50%, as illustrated in FIG. 8.

When silicon (Si) is used as the primary particles P11, silicon dioxide (SiO₂) may be used as the primary particles P12, and the volume, excluding the binder, of silicon (metal) in the composite secondary particles P20 may be set to 10% to 30%, as illustrated in FIG. 8. This can reduce distortion in the three-dimensional object.

When titanium (Ti) is used as the primary particles P11, titanium dioxide (TiO₂) may be used as the primary particles P12, and the volume, excluding the binder, of titanium (metal) in the composite secondary particles P20 may be set to 10% to 40%, as illustrated in FIG. 8. This can reduce distortion in the three-dimensional object.

When hafnium (Hf) is used as the primary particles P11, hafnium dioxide (HfO₂) may be used as the primary particles P12, and the volume, excluding the binder, of hafnium (metal in the composite secondary particles P20 may be set to 20% to 50%, as illustrated in FIG. 8. Thereby, distortion in the three-dimensional object can be reduced.

When yttrium (Y) is used as the primary particles P11, yttrium oxide (III) (Y₂O₃) may be used as the primary particles P12, and the volume, excluding the binder, of yttrium (metal) in the composite secondary particles P20 may be set to 20% to 50%, as illustrated in FIG. 8. Thereby, distortion in the three-dimensional object can be reduced.

When nickel (Ni) is used as the primary particles P11, nickel oxide (II) (NiO) may he used as the primary particles P12, and the volume, excluding the binder, of nickel (metal) in the composite secondary particles P20 may be set to 20% to 50%, as illustrated in FIG. 8. Thereby, distortion in the three-dimensional object can be reduced.

When copper (CU) is used as the primary particles P11, copper oxide (II) (CuO) may be used as the primary particles P12, and the volume, excluding the binder, of copper (metal) in the composite secondary particles P20 may be set to 20% to 40%, as illustrated in FIG. 8. Thereby, distortion in the three-dimensional object can be reduced.

When cobalt (Co) is used as the primary particles P11, cobalt oxide (II) (CoO) may be used as the primary particles P12, and the volume, excluding the binder, of cobalt (metal) in the composite secondary particles P20 may be set to 20% to 40%, as illustrated in FIG. 8. Thereby, distortion in the three-dimensional object can be reduced.

When iron (Fe) is used as the primary particles P11, iron oxide (III) (Fe₂O₃) may be used as the primary particles P12, the volume, excluding the binder, of iron (metal) in the composite secondary particles P20 may be set to 20% to 30%, as illustrated in FIG. 8. Thereby, distortion in the three-dimensional object can be reduced.

When tungsten (W) is used as the primary particles P11, tungsten oxide (VI) (WO₃) may be used as the primary particles P12. The volume, excluding the binder, of tungsten (metal) in the composite secondary particles P20 may be set to 5% to 15%, as illustrated in FIG. 8. Thereby, distortion in the three-dimensional manufactured object can be reduced.

In this case, the ratio of the primary metallic particles to the secondary particles P20 does not matter practically as long as it falls within the metal volume ranges illustrated in FIG. 8. With an increase in the ratio of the primary metallic particles to the secondary particles P20, however, the metallic primary particles are typically larger in size than the primary particles of the metal oxide, so that the density of the three-dimensional object is likely decreased. Thus, the secondary particles P20 are preferably created at a smaller volume ratio of the metallic primary particles.

The above explanation does not include the particle size of the primary particles P11 and P12 in detail. Decreasing the particle size of the metal oxide (submicron size) enhances the sinterability, and increases the volume shrinkage associated with sintering. By setting the metal volumes to the higher values in FIG. 8, distortion in the three-dimensional object can be inhibited, but the effect is assumed to be small.

### [4] Modifications of Embodiments

The above embodiments have described forming and adding the powder layers of the secondary particles P20 by a material deposition method for additive manufacturing. Modifications of the embodiments use an additive manufacturing apparatus employing a binder jetting method.

### [4.1] First Modification

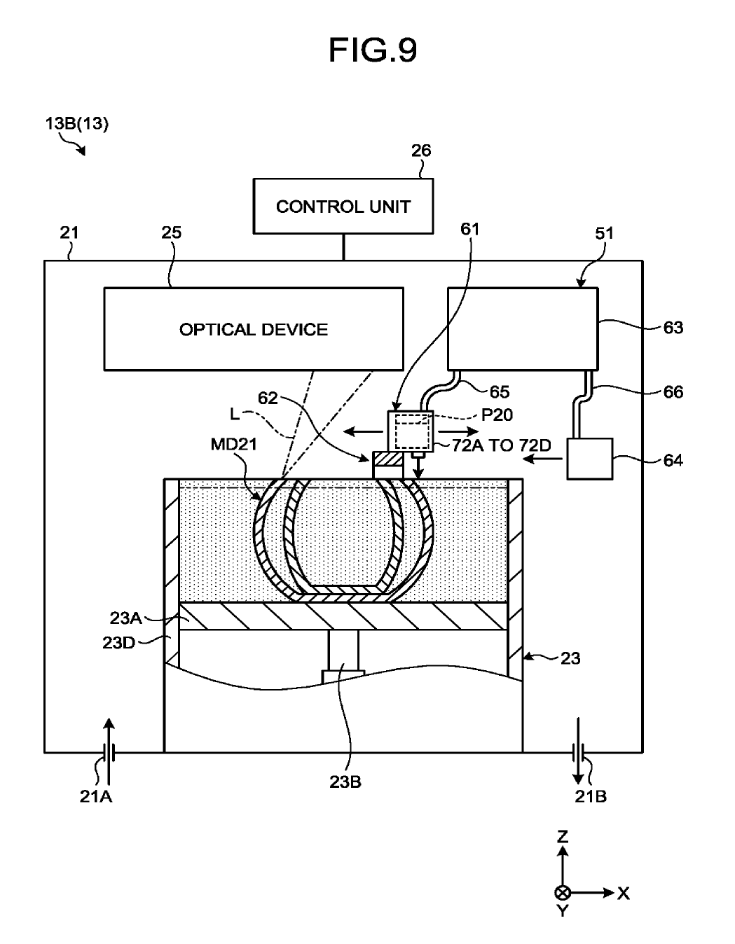

FIG. 9 is a schematic sectional view of a three-dimensional printer according to a first modification of the embodiments. A three-dimensional printer 13B is a three-dimensional manufacturing apparatus that employs the binder jetting. In FIG. 9, same or like components as those of the first embodiment in FIG. 2 are denoted by the same reference numerals, and the detailed explanation thereof is incorporated.

As illustrated in FIG. 9, the three-dimensional printer 13B includes the treatment chamber 21, the manufacturing tank 23, a supply device 51, the optical device 25, and the control unit 26. In a case where the materials, the secondary particles P20 are bonded by means other than the laser light L, the three-dimensional printer 13B does not need to include the optical device 25.

The manufacturing tank 23 includes the stage 23A, the hydraulic lifting device 23B, and a peripheral wall 23D. The secondary particles P20 as the materials are sequentially supplied onto the top face of the stage 23A based on slice data.

The supply device 51 supplies the secondary particles P20 above the stage 23A in the manufacturing tank 2, and additively forms and bonds layers of the supplied secondary particles P20 with a binding agent such as an adhesive. The supply device 51 includes an ejector 61, a mover 62, a container 63, and a collector 64. The ejector 61 ejects the secondary particles P20 as the raw materials and the binding agent. The mover 62 moves the ejector 61. The container 63 accommodates the raw materials. The collector 64 collects the raw materials that are not used for manufacturing.

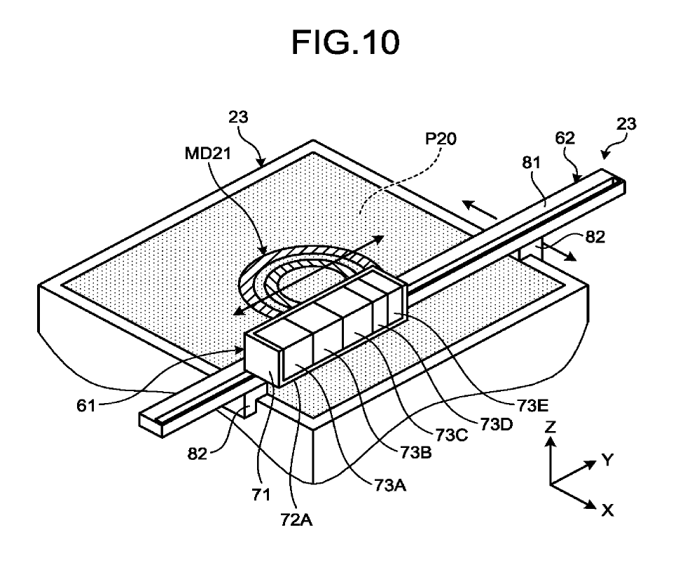

FIG. 10 is a perspective view of an essential part of the manufacturing tank and the supply device. As illustrated in FIG. 10, the ejector 61 of the supply device 51 includes a holder 71, nozzles 72A to 72E, and tanks 73A to 73E. The nozzles 72A to 72E are provided integrally with the holder 71. The tanks 73A to 73E correspond to the nozzles 72A to 72D.

The holder 71 holds the tanks 73A to 73B and includes the nozzles 72A to 72E on the bottom face corresponding to the tanks 73A to 73E.

In the above configuration, the tanks 73A to 73C may store therein the same secondary particles P20 or different kinds of secondary particles P20, for example. The tank 72D stores therein a predetermined binding agent and the tank 73E stores therein a solvent for the binding agent, for example.

To simplify the explanation, the following describes the tanks 73A to 73C containing the same secondary particles P20, for example.

The mover 72 includes a rail 81 and a pair of conveyers 82. The mover 72 moves the ejector 61 in X-axis and Y-axis directions, to move the tanks 73A to 73C integrated with the holder 71 of the ejector 61 with respect to the manufacturing tank 23.

The rail 81 is placed above the manufacturing tank 23 and is longer than the manufacturing tank in the Y-axis direction. The holder 71 of the ejector 61 is movable along the rail 81. The ejector 61 is driven along the rail 81 by a mechanism including various parts such as a motor, a gear, and a belt. The nozzles 72A to 72E of the ejector 61 are also moved along the rail 81 to eject the secondary particles P20 and the binding agent and additively form the layers of the secondary particles P20 in the manufacturing tank 23.

The collector 64 is connected to the container 63 through a collector tube 86. The collector 64 suctions not-bonded, powdery secondary particles P20 and transmits them to the container 63 for collection.

Owing to the above configuration, the control unit 26 controls the manufacturing tank 23, the supply device 51, and the optical device 25 to additively manufacture a three-dimensional object MD21 by mutually bonding the secondary particles coated with the binding agent with the optical device. The control unit 26 further controls the collector 64 so as to suction the powdery secondary particles P20 unused for the manufacturing and transmit them to the container 63 for collection.

The three-dimensional object MD manufactured as described above is subjected to the pressurization process, (the filling process), and the sintering process, and formed into a sintered compact, as with the first embodiment and the second embodiment.

As described above, the first modification of the embodiments can also reduce manufacturing costs and provide densified three-dimensional objects (three-dimensional structure) having higher density and strength.

### [4.2] Second Modification

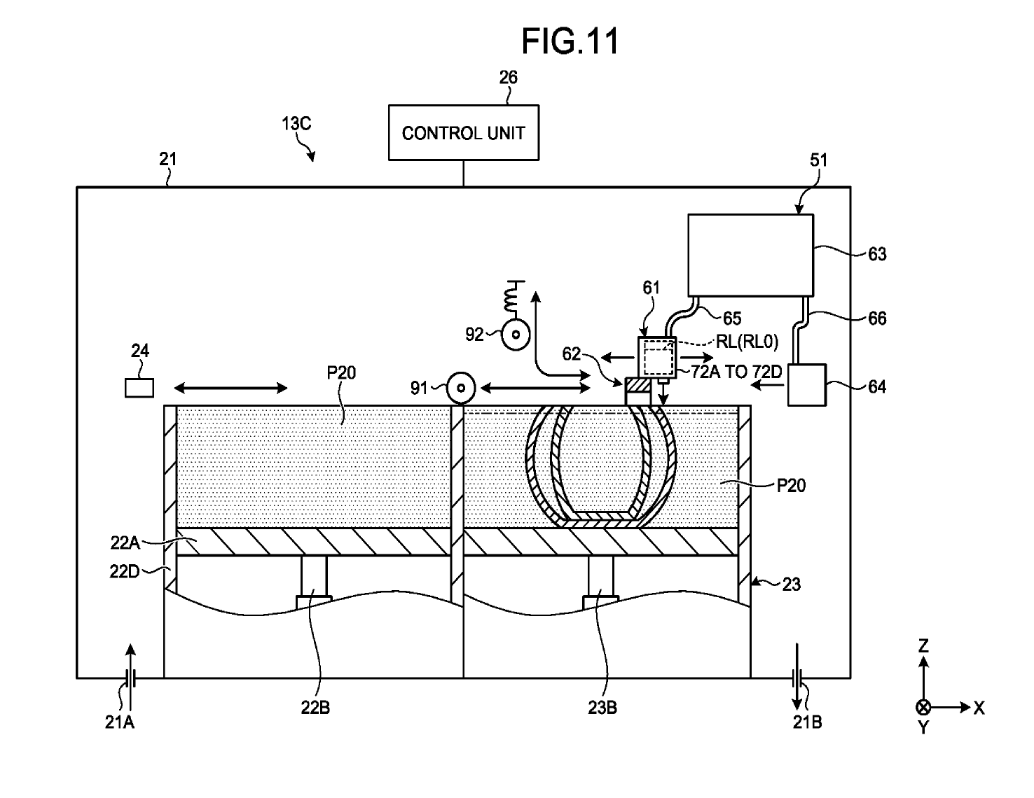

FIG. 11 is a schematic sectional view of the three-dimensional printer according to a second modification of the embodiments. In FIG. 11, same or like components as those in FIG. 9 are denoted by the same reference numerals. Similarly to the three-dimensional printer 13B illustrated in FIG. 9, a three-dimensional printer 13C employs the bond jetting.

As illustrated in FIG. 10, the three-dimensional printer 13C includes the treatment chamber 21, the material tank 22, the manufacturing tank 23, the wiper device 24, and an inkjet manufacturing device 51. The material tank 22 accommodates raw materials (secondary particles) used to manufacture a three-dimensional object. The manufacturing tank 23 is for actual three-dimensional manufacturing. The wiper device 24 supplies the raw materials from the material tank 22 to the manufacturing tank 23. The inkjet manufacturing device 51 applies, through an inkjet head, a binding agent RL to each layer of the raw materials (secondary particles), supplied by the wiper device 24 to the manufacturing tank 23, at a position (pattern) corresponding to each layer of the three-dimensional object corresponding to slice data.

The three-dimensional printer 13C further includes the control unit 26, a leveling roller 91, and a press roller 92. The control unit 26 controls the material tank 22, the manufacturing tank 23, and the wiper device 24. The leveling roller 91 levels the secondary particles P20, supplied to the manufacturing tank 23 by the wiper device 24, to a uniform thickness. The press roller 92 applies pressure to (presses) the top face of the secondary particles P20 coated with the binding agent RL by the inkjet manufacturing device 51, thereby increasing the density of the three-dimensional manufactured object.

In this case, by the pressure from the press roller 92, a solution in the binding agent RL applied by the inkjet manufacturing apparatus 51 dissolves the secondary particles P20, which facilitates crushing and deforming of the secondary particles P20 at the time of pressing by the press roller 92 and thereby further increases the density.

In the above configuration, the treatment chamber 21 has a sealed space inside. The material tank 22, the manufacturing tank 23, the wiper device 24, and the optical device 25 are arranged at predetermined positions in the treatment chamber 21. The treatment chamber 21 is supplied with the inert gas, such as nitrogen and argon, from the gas supplier (not illustrated) through the supply port 21A to maintain the cleanliness inside the treatment chamber. Excessive gas components generated in the three-dimensional manufacturing are exhausted to outside the treatment chamber 21 through the vent 21B.

The material tank 22 includes inside the stage 22A which can be ascended and descended by the hydraulic lifting device 22B. The secondary particles P20 serving as the raw materials are placed on the stage. In the three-dimensional manufacturing, the stage ascends at each predetermined manufacturing step, moving the raw materials of an amount corresponding to a predetermined layer thickness upward in the material tank 22

The manufacturing tank 23 includes the stage 23A, the hydraulic lifting device 23B, and the peripheral wall 23D. The secondary particles P20 being the materials are sequentially supplied to the top face of the stage 23A based on slice data.

The wiper device 24 includes the squeezing blade. The squeezing blade is horizontally driven in FIG. 2, to supply, to the manufacturing tank 23, the raw materials of the amount corresponding to the predetermined layer thickness moved upward in the material tank 22. The leveling roller 91 levels the secondary particles P20, supplied to the manufacturing tank 23 by the wiper device 24, to a uniform thickness.

The inkjet manufacturing device 51 ejects the binding agent RL onto the surface of the secondary particles P20 supplied to the manufacturing tank 23, to bind the secondary particles P20 with each other, and additively forms and bonds the layer of the secondary particles P20 for the three-dimensional manufacturing. Before the binding agent RL is completely bonded, the press roller 92 applies pressure to (presses) the top face of the secondary particles coated with the binding agent RL by the inkjet manufacturing device 51, thereby increasing the density of the three-dimensional object.

In the above configuration, the inkjet manufacturing device 51 includes the ejector 61, the mover 62, the container 63, and the collector 64. The ejector 61 ejects the binding agent RL to the secondary particles P20 supplied to the manufacturing tank 23. The mover 62 moves the ejector 61. The container 63 accommodates the raw materials. The collector 64 collects the raw materials (secondary particles) that are not used for manufacturing.

The mover 62 includes the rail 81 and the pair of conveyers 82. The mover 62 moves the ejector 61 in the X-axis and Y-axis directions, to move the tanks 73A to 73E integrated with the holder 71 of the ejector 61 with respect to the manufacturing tank 23.

The rail 81 is placed above the manufacturing tank 23 and is longer than the manufacturing tank in the Y-axis direction. The holder 71 of the ejector 61 can be moved along the rail 81. By driving a mechanism including various parts such as a motor, a gear, and a belt, the ejector 61 is moved along the rail 81. The nozzles 72A to 72E of the ejector 61 are also moved along the rail 81 and eject the binding agent RL to additively form layers of the secondary particles P20 in the manufacturing tank 23 for the three-dimensional manufacturing.

The collector 64 is connected to the container 63 through the collection tube 86 to suction not-bonded, powdery secondary particles P20 and transmits them to the container 63 for collection.

With the above configuration, the control unit 26 controls the manufacturing tank 23, the supply device 51, and the optical device 25 for additively manufacturing the three-dimensional object MD21 by mutually bonding the secondary particles coated with the binding agent RL with the optical device. Furthermore, the control unit 26 controls the collector 64 so as suction the powdery secondary particles P20 not used for the manufacturing and transmit them to the container 63 for collection.

The three-dimensional object manufactured as described above is subjected to the pressurization process, (the filling process), and the sintering process and formed into a sintered compact, as with the first embodiment and the second embodiment. Alternatively, the manufactured three-dimensional object is subjected to the sintering process and formed into a sintered compact.

As described above, the second modification of the embodiments can also reduce manufacturing costs and can provide densified three-dimensional objects (three-dimensional structure) having higher density and strength.

While certain embodiments of the present invention have been described, these embodiments are given by way of example only and are not intended to limit the scope of the invention. The novel embodiments may be embodied in a variety of other forms, and various omissions, substitutions, and changes may be made without departing from the spirit of the invention. The embodiments and the modifications thereof are included in the scope and the spirit of the invention and in the invention described in the claims and their equivalents.

While the above embodiments use the same secondary particles for three-dimensional manufacturing, different kinds of secondary particles can be used for three-dimensional manufacturing, for example.

1. A three-dimensional manufacturing method comprising:
forming and adding a layer of secondary particles to manufacture a three-dimensional object, the secondary particles obtained by granulating primary particles; and
heating the three-dimensional object to produce a sintered compact.

2. The three-dimensional manufacturing method according to claim 1, wherein the secondary particles are obtained by granulating a plurality of kinds of the primary particles.

3. The three-dimensional manufacturing method according to claim 1, further comprising:
applying isotropic pressure under a cold condition to the manufactured three-dimensional object, wherein
the heating includes heating the three-dimensional object after the isotropic pressure application and producing the sintered compact.

4. The three-dimensional manufacturing method according to claim 2, wherein
the three-dimensional object has a recess, the three-dimensional manufacturing method further comprising
after the forming and adding and before the applying, filling the recess with a core member to maintain a shape of the recess in the pressurization process, the core member being made of a material removable by heating in the heating.

5. The three-dimensional manufacturing method according to claim 1, wherein the primary particles include a plurality of kinds of primary particles having different outer shapes.

6. The three-dimensional manufacturing method according to claim 1, wherein the primary particles include a base and a sintering aid that aids the sintering.

7. The three-dimensional manufacturing method according to claim 1, wherein the first particles include nanoparticles having a nanometer-order size.

8. The three-dimensional manufacturing method according to claim 1, wherein the secondary particles are a plurality of kinds of secondary particles.

9. A three-dimensional manufacturing method comprising:
granulating secondary particles including primary particles having a metal as a main component and primary particles as an oxide of the metal; and
forming and adding a layer of the secondary particles to manufacture a three-dimensional object.

10. The three-dimensional manufacturing method according to claim 9, further comprising
reacting and sintering the three-dimensional object by heating to produce a sintered compact.

11. The three-dimensional manufacturing method according to claim 9, wherein the secondary particles include the primary particles of the metal and the primary particles of the metal oxide at a predetermined volume ratio at which a decrease in volume associated with the sintering can be at least partially offset by an increase in volume associated with oxidation of a metallic material.
